(19) United States
(12) Patent Application Publication
(10) Pub. No.: US 2012/0294120 A1
(43) Pub. Date: Nov. 22, 2012

(54) ULTRASONIC SPEAKER, PARAMETRIC SPEAKER HAVING THE SAME AND VEHICLE PROXIMITY ANNUNCIATOR DEVICE HAVING THE SAME

(75) Inventors: Kouji Sakurai, Chita-gun (JP); Toshiaki Nakayama, Miyoshi-city (JP); Toshio Hayashi, Obu-city (JP)

(73) Assignee: DENSO CORPORATION, Kariya-city (JP)

(21) Appl. No.: 13/439,102

(22) Filed: Apr. 4, 2012

(30) Foreign Application Priority Data
May 20, 2011 (JP) 2011-113679
Jul. 8, 2011 (JP) 2011-151887

(51) Int. Cl. H04B 1/02

(52) U.S. Cl. 367/137

(57) ABSTRACT

An ultrasonic emission device is accommodated in a housing for generating an ultrasonic wave. The housing has an ultrasonic emission port for emitting the ultrasonic wave from the ultrasonic emission device outward therethrough. A louver is equipped to the ultrasonic emission port. The louver includes multiple louver boards, which are distant from each other. Two of the multiple louver boards adjacent to each other form a clearance therebetween. The clearance includes a horizontal clearance extending along a horizontal direction and an inclined clearance being an ascent inclination toward the ultrasonic emission device.

### CROSS REFERENCE TO RELATED APPLICATIONS

This application is based on reference Japanese Patent Applications No. 2011-113679 filed on May 20, 2011 and No. 2011-151887 filed on Jul. 8, 2011, the disclosure of which is incorporated herein by reference.

### TECHNICAL FIELD

The present disclosure relates to an ultrasonic speaker including a louver. The present disclosure further relates to a parametric speaker equipped with the ultrasonic speaker and configured to emit an ultrasonic wave. The present disclosure further relates to a vehicle proximity annunciator device equipped with the ultrasonic speaker and configured to cause the ultrasonic speaker to notify existence of a vehicle.

### BACKGROUND

As follows, the background will be described with a vehicle proximity annunciator device as an example of the present disclosure. For example, JP-A-2005-289175 discloses a vehicle proximity annunciator device for emitting an annunciation sound to notify a pedestrian therearound of existence of a vehicle, which is configured to emit small operation noise. The vehicle proximity annunciator device of JP-A-2005-289175 is configured to cause a dynamic speaker to emit an annunciation sound.

It is conceivable to employ a parametric speaker in such a vehicle proximity annunciator device, in consideration of high directivity of the parametric speaker to cause an annunciation sound at a place distant from the vehicle. The parametric speaker is configured to implement ultrasonic modulation of a waveform signal of an audible annunciation sound and to cause an ultrasonic speaker to emit the modulated annunciation sound. With the present configuration, a modulating component included in the ultrasonic wave (non-audible sound wave) emitted from the ultrasonic speaker is self-modulated through the air in the course of transmission thereby to cause an audible annunciation sound at a place distant from the vehicle.

For example, the ultrasonic speaker is located inside a front grill of a vehicle to enable emission of an ultrasonic wave effectively outward from the vehicle. In consideration of the operation, the ultrasonic speaker is, in general, located at a place where rainwater applied with wind pressure may intrude. In consideration of this, it is demanded to restrict rainwater from intruding into an ultrasonic speaker to protect an ultrasonic emission device being aggregate of multiple ultrasonic wave generation elements inside the ultrasonic speaker from rainwater.

For example, JP-A-2005-184365 discloses a water-resistant unit for restricting rainwater from intruding into an ultrasonic speaker. As follows, an example of a water-resistant unit will be described with reference to FIG. 9. The water-resistant unit shown in FIG. 9 includes:

(i) a waterproof sheet 10 surrounding an ultrasonic emission port 4a, the waterproof sheet 10 being a waterproof and breathable film member configured to transmit an ultrasonic wave therethrough and to restrict rainwater from passing therethrough; and

(ii) a louver 6 located on a front side of the waterproof sheet 10, the louver 6 including multiple louver boards 5 each inclined at about 45 degrees relative to the forward and backward direction of the vehicle and spaced from each other for restricting rainwater from intruding into the waterproof sheet 10 as much as possible.

More specifically, the longitudinal direction each of the multiple louver boards 5 is arranged along the horizontal direction. The multiple louver boards 5 are distant from each other to define clearances in the louver 6. Each of the louver boards 5 is inclined at 45-degree to define an ascent slope toward an ultrasonic emission device 3. In the present configuration, as shown by the solid line A in FIG. 9, the louver boards 5 redirect an ultrasonic wave emitted from the ultrasonic emission device 3 downward with the inner surfaces of the louver boards 5. The louver boards 5 again redirect the ultrasonic wave upward with the outer surfaces of the louver boards 5 on the lower side. Thus, the redirected ultrasonic wave is emitted in the traveling direction of the vehicle.

It is noted that, the louver 6 is demanded not to allow rainwater flowing from the front side to reach the ultrasonic emission device 3 and the waterproof sheet 10 as much as possible. In consideration of this, it is conceivable to reduce the distance between the louver boards 5 adjacent to each other thereby to reduce a passage width γ of rainwater formed between the louver boards 5 adjacent to each other.

It is further noted that, as shown in the encircled portion B in FIG. 9, the end of each louver board 5 of the louver 6 reflects the ultrasonic wave, which is emitted from the ultrasonic emission device 3, toward the ultrasonic emission device 3.

Accordingly, when the number of the louver boards 5 is increased to reduce the distance between the adjacent louver boards 5, the rate of ultrasonic waves reflected on the end of the louver board 5 increases. Consequently, the radiant efficiency of the ultrasonic wave decreases. In short, when the number of louver boards 5 is increased in order to restrict rainwater from passing therethrough, the rate of reflection increases to impair radiant efficiency of the ultrasonic wave.

### SUMMARY

It is an object of the present disclosure to produce an ultrasonic speaker including a louver configured to restrict rainwater from passing therethrough while maintaining radiant efficiency of an ultrasonic wave. It is another object of the present disclosure to produce a parametric speaker equipped with the ultrasonic speaker. It is another object of the present disclosure to produce a vehicle proximity annunciator device equipped with the ultrasonic speaker and configured to cause the ultrasonic speaker to notify existence of a vehicle.

According to an aspect of the present disclosure, an ultrasonic speaker comprises an ultrasonic emission device configured to generate an ultrasonic wave. The ultrasonic speaker further comprises a housing accommodating the ultrasonic emission device, the housing having an ultrasonic emission port for emitting the ultrasonic wave from the ultrasonic emission device outward therethrough. The ultrasonic speaker further comprises a louver equipped to the ultrasonic emission port, the louver including a plurality of louver boards, which are distant from each other to form a clearance therebetween. Each clearance between the plurality of louver boards includes both: a horizontal clearance extending along a horizontal direction; and an inclined clearance being an ascent inclination toward the ultrasonic emission device.

According to another aspect of the present disclosure, an ultrasonic speaker comprises an ultrasonic emission device configured to generate an ultrasonic wave; The ultrasonic speaker further comprises a housing accommodating the ultrasonic emission device, the housing having an ultrasonic emission port for emitting the ultrasonic wave from the ultrasonic emission device outward therethrough. The ultrasonic speaker further comprises a louver equipped to the ultrasonic emission port, the louver including a plurality of louver boards, which are distant from each other. Each pair of the plurality of louver boards adjacent to each other forms a clearance therebetween. The clearance includes both: a horizontal clearance extending along a horizontal direction; and an inclined clearance being at an angle relative to the horizontal direction and being an ascent inclination toward the ultrasonic emission device.

### BRIEF DESCRIPTION OF THE DRAWINGS

The above and other objects, features and advantages of the present invention will become more apparent from the following detailed description made with reference to the accompanying drawings. In the drawings:

FIG. 1 is a partial cross-sectional view showing an ultrasonic speaker according to the first embodiment;

FIG. 2A is a sectional view showing cross sections of louver boards in a louver according to an exemplified embodiment, FIG. 2B is a sectional view showing cross sections of louver boards in a louver according to the first embodiment, and

FIG. 2C is a sectional view showing cross sections of louver boards in a louver according to the second embodiment;

FIG. 3 is a schematic diagram showing a vehicle proximity annunciator device;

FIG. 4A, FIG. 4B, FIG. 4C, FIG. 4D, FIG. 4E, are explanatory views showing transition of a ultrasonic wave emitted from a parametric speaker;

FIG. 5 is a partial cross-sectional view showing an ultrasonic speaker according to the second embodiment;

FIG. 6A, FIG. 6B, FIG. 6C, are partial cross-sectional views each being for explaining a lower edge corner formed in a lower edge of an inclined plate portion of the louver according to the third embodiment;

FIG. 7A is a cross-sectional view showing cross sections of louver boards in a louver according to the fourth embodiment, and FIG. 7B is a cross-sectional view showing a cross section of a horizontal plate according to the fourth embodiment;

FIG. 8 is a cross-sectional view showing louver boards in a louver according to the fifth embodiment; and

FIG. 9 is a partial cross-sectional view showing an ultrasonic speaker according to an example.

### DETAILED DESCRIPTION

As follows, embodiments will be described with reference to drawings.

In the following description, the emission direction of an ultrasonic wave from an ultrasonic speaker is on the front side. It is noted that, the embodiments do not limit the loading direction of the ultrasonic speaker in an actual vehicle.

A vehicle proximity annunciator device is configured to notify existence of a vehicle by causing an annunciation sound, such as a monotone sound, a chord sound, a music, a voice, a dummy engine sound, and/or the like. The vehicle proximity annunciator device includes a parametric speaker 1 configured to emit an ultrasonic wave, which is generated by implementing ultrasonic modulation on an annunciation sound, outward from the vehicle. The parametric speaker 1 includes an ultrasonic speaker 2 configured to emit the ultrasonic wave. The ultrasonic speaker 2 includes:

an ultrasonic emission device 3 configured to emit an ultrasonic wave;

a housing 4 accommodating the ultrasonic emission device 3, the housing 4 having an ultrasonic emission port 4a for emitting the ultrasonic wave emitted from the ultrasonic emission device 3 to the outside; and

a louver 6 equipped to the ultrasonic emission port 4a and configured to include multiple louver boards 5, which are distant from each other to form clearances therebetween.

In the following description, the x-axis is along the emission direction, in which the ultrasonic emission device 3 emits the ultrasonic wave, the y-axis is along the top and bottom direction (vertical direction), and the z-axis is the horizontal direction. The x-axis intersects to the y-axis and the z-axis. Each of the louver boards 5 is arranged, such that its longitudinal direction is along the y-axis direction. Each of the louver boards 5 includes both:

(i) a horizontal plate portion 5a along the x-axis direction and the horizontal direction; and

(ii) an inclined plate portion 5b defining an ascent slope toward the ultrasonic emission device 3.

In the present configuration, the louver boards 5 adjacent to each other form both a horizontal clearance α and an inclined clearance β along the emission direction of the ultrasonic wave. The horizontal clearance α is along the horizontal direction and is formed between the horizontal plate portions 5a adjacent to each other. The inclined clearance β is defined by the ascent slope directed toward the ultrasonic emission device 3 and is formed between the inclined plate portions 5b adjacent to each other.

### EMBODIMENTS

As follows, a detailed example of application of the present disclosure to the ultrasonic speaker 2 for a vehicle proximity annunciator device will be described with reference to drawings. The following embodiments are examples, and the present disclosure is not limited to the embodiments.

### First Embodiment

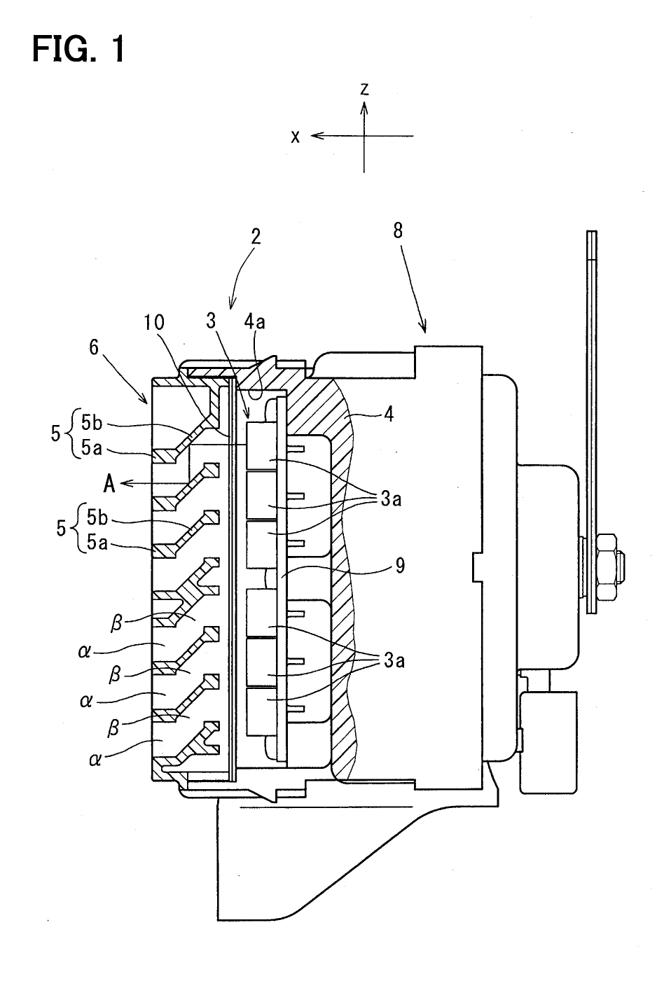

As follows, the first embodiment will be described with reference to FIG. 1 to FIG. 4. The vehicle proximity annunciator device is configured to notify existence of a vehicle by causing an annunciation sound, such as a monotone sound, a chord sound, a music, a voice, a dummy engine sound, and/or the like. The vehicle proximity annunciator device may be equipped to, for example, a vehicle, which is not equipped with an internal combustion engine, such as an electric vehicle or a fuel cell electric vehicle. Alternatively, the vehicle proximity annunciator device may be equipped to a vehicle, which is configured to stop its internal combustion engine while traveling and stopping, such as a hybrid vehicle. Alternatively, the vehicle proximity annunciator device may be equipped to a vehicle, which is configured to stop its internal combustion engine when stopping, such as an idle-stop vehicle. Alternatively, the vehicle proximity annunciator device may be equipped to a conventional vehicle configured to emit a small sound from its internal combustion engine and the vehicle when traveling.

The vehicle proximity annunciator device employs the parametric speaker 1 and a control circuit 7. The control circuit 7 controls operation of the ultrasonic speaker 2 of the parametric speaker 1 for emitting an ultrasonic wave. The ultrasonic speaker 2 is configured to cause aerial vibration at a high frequency, which is beyond a human audible range and is higher than 20 kHz. The ultrasonic speaker 2 is equipped to a vehicle and is configured to emit an ultrasonic wave ahead the vehicle.

FIG. 1 shows a detailed example of the ultrasonic speaker 2. The ultrasonic speaker 2 is equipped to a front surface of a vehicular horn buzzer 8, which emits an alarm sound when a horn buzzer switch device is operated by an occupant. More specifically, the ultrasonic speaker 2 is directed to the front side of the vehicle when equipped to the vehicle. The ultrasonic speaker 2 may be equipped to a front surface of a swirl horn buzzer, as illustrated in FIG. 1. The ultrasonic speaker 2 is equipped to the front surface of the vehicular horn buzzer 8, in this way. Therefore, by mounting the vehicular horn buzzer 8 between a front grill and a heat exchanger, such as a radiator or an air-conditioning heat exchanger, the ultrasonic emission port 4a is directed to the front side of the vehicle when the ultrasonic speaker 2 is equipped to the vehicle.

The ultrasonic speaker 2 includes an ultrasonic emission device 3 for emitting an ultrasonic wave and the housing 4 for accommodating the ultrasonic emission device 3. The housing 4 has the ultrasonic emission port 4a for emitting the ultrasonic wave therethrough. The housing 4 may be integrated with the vehicular horn buzzer 8 or may be a separate component from the vehicular horn buzzer 8. The ultrasonic emission device 3 includes multiple ultrasonic wave generation elements 3a being an aggregate located on the same plane for emitting a compressional wave in an ultrasonic wavelength to the air. Specifically, for example, the multiple ultrasonic wave generation elements 3a are equipped as multiple components on a support plate 9 inside the housing 4 to configure a speaker array.

Each of the ultrasonic wave generation elements 3a may be a small piezoelectric speaker including a piezo-electric element and a supersonic oscillation plate. The piezo-electric element implements extension and contraction according to an applied voltage to cause charge and discharge. The supersonic oscillation plate is actuated by the extension and contraction of the piezo-electric element thereby to cause air to generate the compressional wave. The ultrasonic emission port 4a is an opening for emitting an ultrasonic wave caused by the multiple ultrasonic wave generation elements 3a of the ultrasonic emission device 3 to the front side of the vehicle. The ultrasonic emission port 4a is equipped with a water-resistant unit for restricting rainwater from infiltrating into the loading section of the ultrasonic emission device 3.

The water-resistant unit includes a combination of:
a waterproof sheet 10 surrounding the ultrasonic emission port 4a and transmitting the ultrasonic wave; and
a louver 6 equipped to the front side of the waterproof sheet 10.

The waterproof sheet 10 surrounds the entire surface of the ultrasonic emission port 4a. The waterproof sheet 10 is, for example, an acoustic-use screen excellent in waterproofness and permeability of an ultrasonic wave. More specifically, the waterproof sheet 10 may be in a fabric form or in a film form having an air permeability to allow air to pass therethrough and waterproofness not to allow water to pass therethrough. Specifically, for example, the waterproof sheet 10 may be a felt cloth (nonwoven fabric) having a waterproofed characteristics and a breathability. More specifically, the waterproof sheet 10 may be a felt cloth formed of a water-repellent textile or a felt cloth with a water-repellent finish treatment. The waterproof sheet 10 has the waterproof characteristic in dependence upon the density and the thickness of the felt cloth. The felt cloth taken in the embodiment is one example of the waterproof sheet 10. The waterproof sheet 10 is not limited to the felt cloth. For example, the waterproof sheet 10 may be formed of various seat materials, which has a waterproof characteristic and an ultrasonic permeable characteristic, such as a textile with a waterproofing treatment and/or Gore-Tex®.

The louver 6 is equipped to the ultrasonic emission port 4a for the purpose of reducing rain water reaching the waterproof sheet 10 as much as possible.

Specifically, the louver 6 may be equipped to the front surface of the waterproof sheet 10. The louver 6 is configured with long and thin louver boards 5 arranged in parallel with each other and distant from each other.

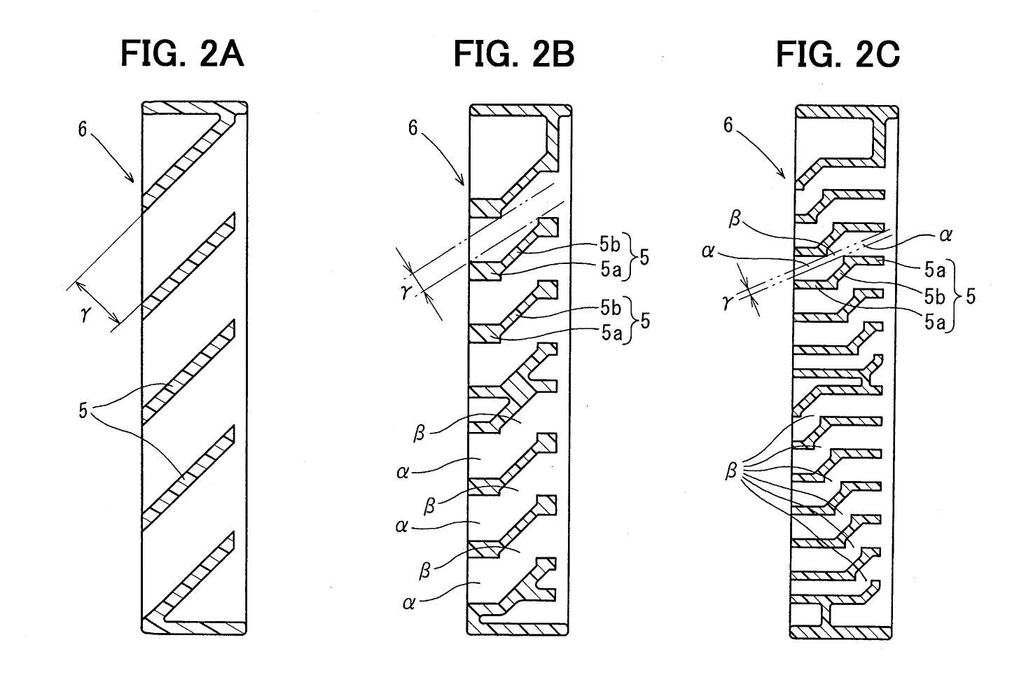

First, an existing louver 6 will be described with reference to FIG. 2A. Each of existing louver boards 5 is in a planar plate shape and inclined at 45 degrees relative to the vehicle horizontal direction. The existing louver boards 5 equipped to the ultrasonic emission port 4a redirect an ultrasonic wave emitted from the ultrasonic emission device 3 downward with the inner surfaces of the louver boards 5. The existing louver boards 5 again redirect the ultrasonic wave upward with the outer surfaces of the louver boards 5 on the lower side. Thus, the redirected ultrasonic wave is emitted in the traveling direction of the vehicle.

It is noted that, the louver 6 is demanded not to allow rainwater flowing from the front side to reach the waterproof sheet 10 as much as possible. That is, the louver 6 is demanded to avoid rainwater from passing therethrough effectively. In consideration of this, it is conceivable to reduce the distance between the existing louver boards 5 adjacent to each other in FIG. 2A thereby to reduce a passage width γ of rainwater formed between the louver boards 5 adjacent to each other. Nevertheless, when the number of the louver boards 5 is simply increased in order to reduce the distance between the adjacent louver boards 5, many of the ultrasonic waves may be reflected on the ends of the louver boards 5 and returned to the ultrasonic wave generation device. Consequently, the radiant efficiency of the ultrasonic waves relative to the front side may decrease.

In consideration of this, the louver 6 of the first embodiment employs the configuration shown in FIG. 2B. Specifically, in the louver 6 of the first embodiment, each of the adjacent louver boards 5 defines, therebetween, both:
a horizontal clearance a along the horizontal direction; and
an inclined clearance β being a 45-degree ascent slope relative to the direction leading to the ultrasonic emission device 3.

The present configuration will be described further in detail. In the state where the ultrasonic speaker 2 is equipped in the vehicle, directions are defined that:

an x-axis is a emission direction in which the ultrasonic emission device 3 emits the ultrasonic wave, the x-axis being along the front-back direction of the vehicle in the present embodiment;

a y-axis ((not shown)) is in the horizontal direction perpendicular to the x-axis, the y-axis being along the horizontal direction of the vehicle; and

a z-axis is in the vertical direction, the z-axis being along the vertical direction of the vehicle.

In the present embodiment, the x-axis, which is the emission direction of the ultrasonic wave from the ultrasonic emission device 3, is horizontal. That is, both the x-axis and the y-axis extend horizontally.

Each of the louver boards 5 is arranged, such that its longitudinal direction is along the y-axis direction. As shown in FIG. 2B, each of the louver boards 5 includes both:

(i) the horizontal plate portion 5a along the x-axis direction; and

(ii) the inclined plate portion 5b inclined relative to the x-axis to define a 45-degree ascent slope to the ultrasonic emission device 3.

The present configuration forms:
the horizontal clearance a between each combination of the adjacent horizontal plate portions 5a; and
the inclined clearance 13 between each combination of the adjacent inclined plate portions 5b.

In the present configuration, the multiple louver boards 5 form both the horizontal clearance α and the inclined clearance β therebetween in the emission direction of the ultrasonic wave along the forward and backward direction of the vehicle.

Referring to FIG. 2B, the louver 6 equipped in the ultrasonic emission port 4a directs the ultrasonic wave emitted from the ultrasonic emission device 3, which includes the multiple ultrasonic wave generation elements 3a. Specifically, as shown by the solid line A in FIG. 1, the louver 6 changes the direction of the ultrasonic wave downward with the inner surface of the inclined plate portion 5b. The louver 6 further changes the direction of the ultrasonic wave frontward relative to the vehicle with the outer surface of the inclined plate portion 5b located on the lower side. Thus, the ultrasonic wave is emitted through the horizontal clearance a along the traveling direction of the vehicle. The horizontal clearance a may be formed only on the front side of the inclined clearance 13. Alternatively, the horizontal clearance a may be formed only on the rear side of the inclined clearance 13.

Alternatively, the horizontal clearance a may be formed on both the front side and the rear side of the inclined clearance 13.

(Description of Control Circuit 7)

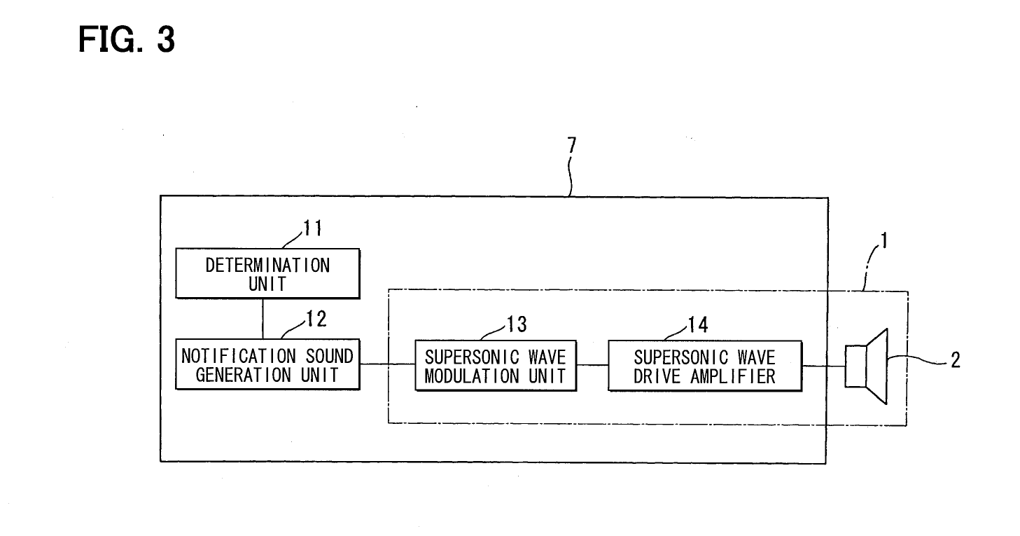

As follows, a detailed example of the control circuit 7 will be described with reference to FIG. 3. The control circuit 7 includes:

(a) a determination unit 11 configured to determine whether the operation state of the vehicle satisfies an emission condition of an annunciation sound;

(b) an annunciation sound generation unit 12 configured to emit a frequency signal for generating the annunciation sound when the determination unit 11 determines that the operation state of the vehicle satisfies the emission condition of the annunciation sound;

(c) an ultrasonic modulation unit 13 configured to modulate the frequency signal for generating the annunciation sound sent from the annunciation sound generation unit 12 into a signal at an ultrasonic frequency; and

(d) an ultrasonic driving power amplifier 14 configured to drive the multiple ultrasonic wave generation elements 3a of the ultrasonic speaker 2.

As follows, each of the units (a) to (d) equipped in the control circuit 7 will be described.

(Description of Determination Unit 11)

When, for example, the vehicle travels at a vehicle speed less than or equal to a predetermined speed such as 20 km/h, the determination unit 11 is configured to determine that the operation state of the vehicle satisfies the emission condition of the annunciation sound thereby to activate the annunciation sound generation unit 12. The present configuration is a detailed example for describing the present embodiment description and does not limit the present disclosure.

(Description of Annunciation Sound Generation Unit 12)

The annunciation sound generation unit 12 is configured with, for example, an annunciation sound generating program (sound software) and is configured to generate the frequency signal for generating the annunciation sound by utilizing a digital technology when receiving an operation instruction from the determination unit 11. The frequency signal is an electric signal at an audible frequency.

(Description of Ultrasonic Modulation Unit 13)

The ultrasonic modulation unit 13 implements ultrasonic modulation on the frequency signal for generating the annunciation sound sent from the annunciation sound generation unit 12. Specifically, in the present embodiment, the ultrasonic modulation unit 13 is, for example, configured to implement amplitude modulation (AM) to modulate the output signal of the annunciation sound generation unit 12 into a predetermined amplitude change at an ultrasonic frequency. The amplitude change is increase and decrease in voltage. The ultrasonic frequency is, for example, about 23 kHz. The ultrasonic modulation unit 13 is not limited to employ the configuration to implement the AM. The ultrasonic modulation unit 13 may be configured to implement pulse width modulation (PWM) to modulate an output signal from the annunciation sound generation unit 12 into a pulse width change (change in time width of a generated pulse) at an ultrasonic frequency.

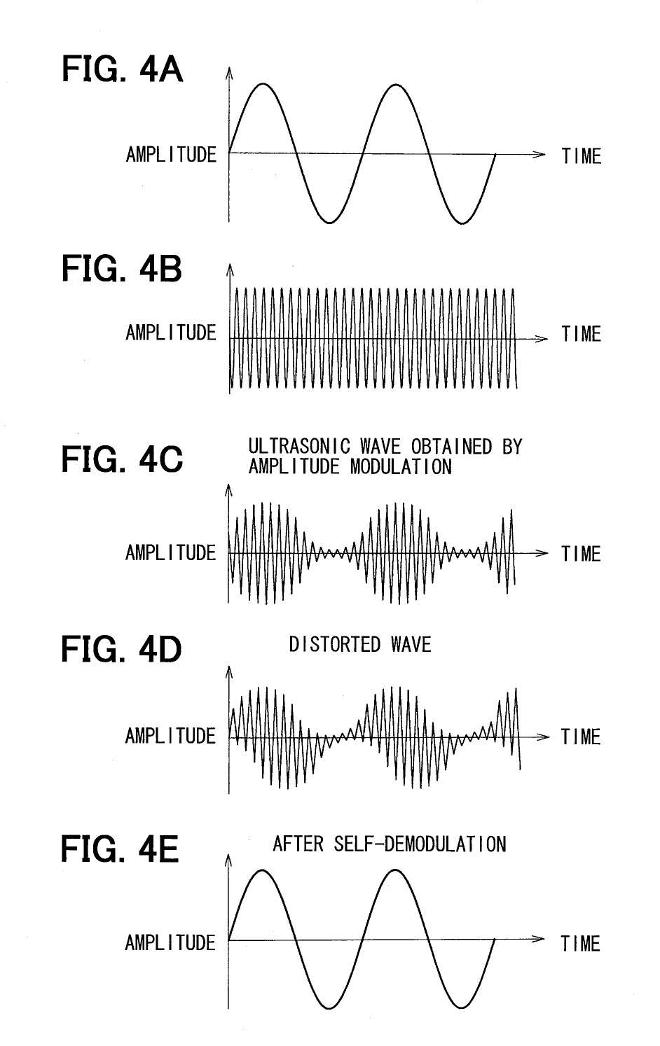

As follows, a detailed example of the ultrasonic modulation implemented with the ultrasonic modulation unit 13 will be described with reference to FIG. 4. For example, it is assumed that the frequency signal for generating the annunciation sound sent into the ultrasonic modulation unit 13 is a voltage change shown in FIG. 4A. FIG. 4A shows a waveform at a single frequency for easy understanding. The ultrasonic modulation unit 13 includes an oscillation unit configured to oscillate at the ultrasonic frequency, as shown in FIG. 4B. The oscillation unit may be a device configured to generate a signal at a predetermined ultrasonic frequency from a clock signal caused for a microcomputer of the control circuit 7. Alternatively, the oscillation unit may be an oscillator independent from the microcomputer chip and configured to implement ultrasonic modulation.

As shown in FIG. 4C, the ultrasonic modulation unit 13 is configured to:

(i) increase the amplitude of the voltage related to supersonic oscillation with increase in the signal voltage of the frequency signal for generating the annunciation sound; and

(ii) decrease the amplitude of the voltage related to supersonic oscillation with decrease in the signal voltage of the frequency signal for generating the annunciation sound.

In this way, the ultrasonic modulation unit 13 is configured to modulate the frequency signal for generating the annunciation sound sent from the annunciation sound generation unit 12 into an amplitude change in the oscillation voltage.

(Description of Ultrasonic Driving Power Amplifier 14)

The ultrasonic driving power amplifier 14 is configured to drive the ultrasonic-emission device 3 of the ultrasonic speaker 2 including the multiple ultrasonic wave generation elements 3a, according to the ultrasonic wave signal modulated with the ultrasonic modulation unit 13. More specifically, the ultrasonic driving power amplifier 14 is, for example, a push-pull power amplifier and is configured to control the applied voltage to each of the ultrasonic wave generation elements 3a thereby to adjust the charge-and-discharge state of each ultrasonic wave generation element 3a. Thus, the ultrasonic driving power amplifier 14 causes each ultrasonic wave generation element 3a to emit the ultrasonic wave generated by modulating the frequency signal for generating the annunciation sound.

(Operation of Vehicle Proximity Annunciator Device)

When the operation state of the vehicle satisfies the emission condition of the annunciation sound, the annunciation sound generation unit 12 sends the frequency signal for generating the annunciation sound. Thus, as shown in FIG. 4C, the ultrasonic speaker 2 emits the ultrasonic wave, which is a non-audible sound wave generated by modulating the frequency signal for generating the annunciation sound to the front side of the vehicle. As the ultrasonic wave propagates through the air, as shown in FIG. 4D, a component of the ultrasonic wave being short in wavelength is distorted and dampened due to, for example, viscosity of the air. Consequently, as shown in FIG. 4E, an amplitude component included in the ultrasonic wave is self-demodulated through the air in the course of its transmission. Thus, the annunciation sound is reproduced on the front side of the vehicle.

### Effect of First Embodiment

As described above, the parametric speaker 1 of the vehicle proximity annunciator device employs the ultrasonic speaker 2. The ultrasonic speaker 2 has both the horizontal clearance α and the inclined clearance β between the multiple louver boards 5 in the louver 6. The horizontal clearance a extends along the x-axis direction, i.e., the horizontal direction. The inclined clearance β is at the inclination angle of 45 degrees relative to the x-axis. Referring to FIG. 2B, the horizontal clearance α and the inclined clearance β are combined and arranged along the emission direction of the ultrasonic wave. The present configuration reduces the passage width γ of rainwater thereby to restrict rainwater from passing though the louver 6.

The combination of the horizontal clearance α and the inclined clearance β enables reduction in the passage width γ of rainwater. Therefore, the number of the louver boards 5 can be suppressed. In addition, the rate of ultrasonic waves, which are re-reflected on the ends of the louver boards 5 and redirected toward the ultrasonic emission device 3, can be reduced. As described in the present embodiment, the louver 6 employed in the ultrasonic speaker 2 enables to maintain the radiant efficiency of the ultrasonic wave and to inhibit passage of rainwater therethrough.

### Second Embodiment

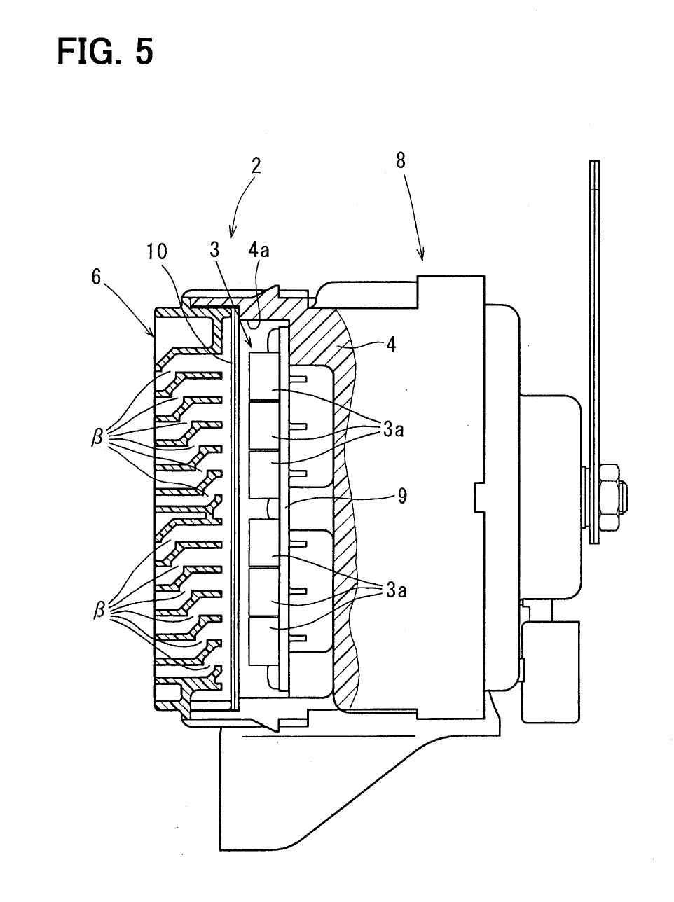

As follows, the second embodiment will be described with reference to FIG. 2C and FIG. 5. In the following embodiments, the same reference numerals as those in the first embodiment denote the same or equivalent functional elements. As shown in FIG. 2C, in the present second embodiment, the configuration of the multiple inclined plate portions 5b employs an inclined arrangement. Specifically, one inclined clearance 13 on the lower side (lower step) is arranged closer to the ultrasonic emission device 3 than the other inclined clearance 13 on the upper side (upper step), when being viewed in the y-axis direction from the lateral side of the vehicle. The inclination arrangement of the multiple inclined plate portions 5b in this way further reduces the passage width γ of rainwater between the louver boards 5 thereby to restrict rainwater from passing therethrough.

### Third Embodiment

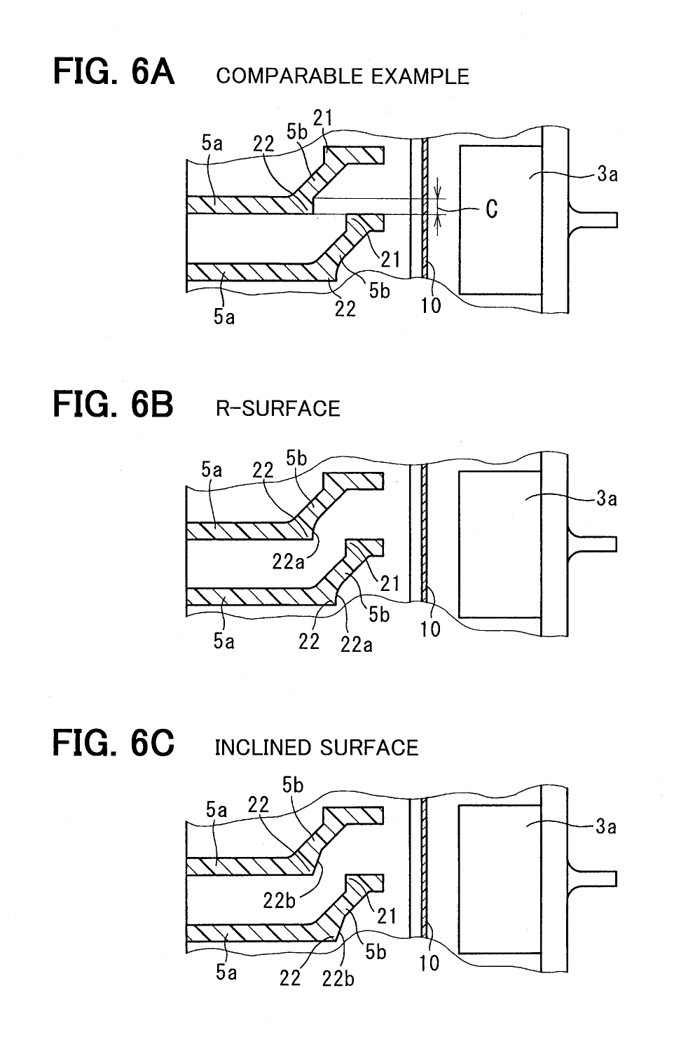

As follows, the second embodiment will be described with reference to FIG. 6. As described above, each of the louver boards 5 includes the horizontal plate portion 5a and the inclined plate portion 5b. In the present configuration including the horizontal plate portion 5a and the inclined plate portion 5b:

(i) the upper edge of the inclined plate portion 5b defines an upper edge corner 21 for extending longevity of a molding die when resin-molding the louver 6; and

(ii) the lower edge of the inclined plate portion 5b defines a lower edge corner 22 for extending longevity of the molding die when resin-molding the louver 6.

Referring to FIG. 6A, each of the upper edge corner 21 and the lower edge corner 22 may be, in general, defined by a vertical plane. The present configuration defines a reflective region C in FIG. 6A to cause the ultrasonic wave reflected on the lower edge corner 22 to be redirected toward the ultrasonic wave generation element 3a. Consequently, the present configuration may reduce the radiant efficiency of the ultrasonic wave emitted to the front side of the vehicle.

In consideration of this, in the present third embodiment, as shown in FIG. 6B, a round surface 22a is formed on the rear surface of the lower edge corner 22 to define an ultrasonic opposed surface opposed to the ultrasonic wave generation elements 3a. The round surface 22a is inclined downward to have the cross section in an arc shape. Alternatively, in the present third embodiment, as shown in FIG. 6C, an angled surface 22b is formed on the rear surface of the lower edge corner 22 to define an ultrasonic opposed surface opposed to the ultrasonic wave generation elements 3a. The angled surface 22b is inclined downward and at a specific angle. The inclination angle of the round surface 22a or the angled surface 22b may be determined in a range not to degrade the molding dies as much as possible when molding the louver 6.

As described in the present third embodiment, the rear surface of the lower edge corner 22 has the round surface 22a or the angled surface 22b inclined downward. In the present configuration, ultrasonic waves colliding on the round surface 22a or the angled surface 22b are partially or entirely reflected and redirected toward the slope of the inclined plate portion 5b or the front surface of the upper edge corner 21 of the louver board 5 on the lower side. Thus, the ultrasonic waves are emitted to the front side of the vehicle from the slope of the inclined plate portion 5b or the front surface of the upper edge corner 21 of the louver board 5 on the lower side. Thus, by employing the present configuration of the round surface 22a or the angled surface 22b according to the present third embodiment, the rate of the ultrasonic waves returning toward the ultrasonic wave generation element 3a can be reduced, and the emission rate of the ultrasonic waves to the front side of the vehicle can be enhanced.

### Fourth Embodiment

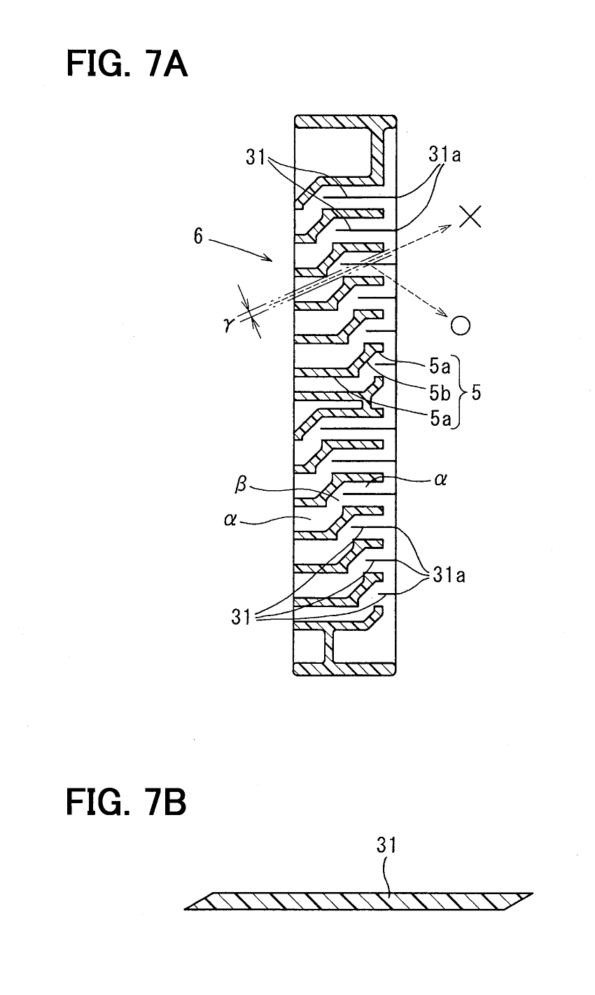

As follows, the fourth embodiment will be described with reference to FIGS. 7A, 7B. It is conceivable that rainwater is strongly blown from the lower side of the louver 6 toward the louver 6 in a case where, for example, the vehicle travels against rainstorm during a typhoon or the vehicle winds up rainwater while traveling at high speed in a rainy weather. In such a case, in the configuration of the louver 6 of the first to third embodiments, as shown by the dashed line arrow x in FIG. 7A, rainwater may partially pass through the passage width γ of rainwater in the louver 6, without touching the louver 6. It is further conceivable that rainwater is strongly blown from the lower side of the louver 6 toward the louver 6, and drips of the rainwater partially collide strongly to the upper edge corner 21 (FIGS. 6A, 6B, 6C) to be atomized partially. In such a case, the atomized rainwater may be applied with wind pressure to flow through the louver 6, and the atomized rainwater may collide against the waterproof sheet 10. Consequently, the atomized rainwater may partially pass through the waterproof sheet 10.

In consideration of this, in the present fourth embodiment, as shown in FIGS. 7A, 7B, a horizontal plate 31 is provided in each horizontal clearance α. The horizontal plate 31 has its plate surface extending in the horizontal direction. Referring to FIG. 7A, the horizontal plate 31 is a thin board located between the horizontal plate portions 5a adjacent to each other to blockade the passage width γ of rainwater when being viewed along the dashed lined directed toward the notation X.

The horizontal plate 31 is integrally formed from resin with each louver board 5. Alternatively, the horizontal plate 31 may be a rectangular thin board formed from a metallic material, such as stainless steel or aluminum. In this case, the horizontal plate 31 may be insert-molded with the louver 6 at both ends in the y-axis direction, i.e., the longitudinal direction of the horizontal plate 31 when the louver 6 is resin-molded.

In the present fourth embodiment, referring to FIG. 7A, the horizontal plate 31 is provided only in the horizontal clearance a on the side of the ultrasonic emission device 3 (FIG. 1) from the inclined clearance β. That is, the horizontal plate 31 is provided on the rear side from the inclined clearance β. In the present configuration, the horizontal plate 31 intersects the passage width γ of rainwater to surround the passage width γ of rainwater. Therefore, even when rainwater is strongly blown from the lower side toward the louver 6, the rainwater can be restricted from passing through the louver 6 without making contact with the inner components, such as the horizontal plate 31, of the louver 6. In this way, the horizontal plate 31 is enabled to avoid direct collision of rainwater with the waterproof sheet 10.

As described above, rainwater may strongly blown from the lower side toward the louver 6 to collide strongly with the inner surface of the louver 6 and atomized. Even in such a condition, when the atomized rainwater collides with the horizontal plate 31 located on the downstream side of the inclined clearance β, the atomized rainwater may be condensed into a water drip on the horizontal plate 31. Thus, as shown by the dashed lined directed toward the notation O, the water drip can be restricted from flowing toward the waterproof sheet 10. Consequently, atomized rainwater can be restricted from passing through the louver 6. Thus, atomized rainwater can be restricted from colliding with the waterproof sheet 10. In the present configuration, the horizontal plate 31 further enhances waterproofness of the ultrasonic speaker 2.

Referring to FIG. 7B, in the present fourth embodiment, the surface of a tip end 31a of the horizontal plate 31 on the side of the ultrasonic emission device 3 is entirely sharpened acutely. With the present configuration, the tip end 31a of the horizontal plate 31 is less apt to reflect the ultrasonic wave, which is emitted from the ultrasonic emission device 3, toward the ultrasonic emission device 3. Therefore, reduction in the radiant efficiency of the ultrasonic wave due to reflection on the tip end 31a of the horizontal plate 31 can be avoidable.

### Fifth Embodiment

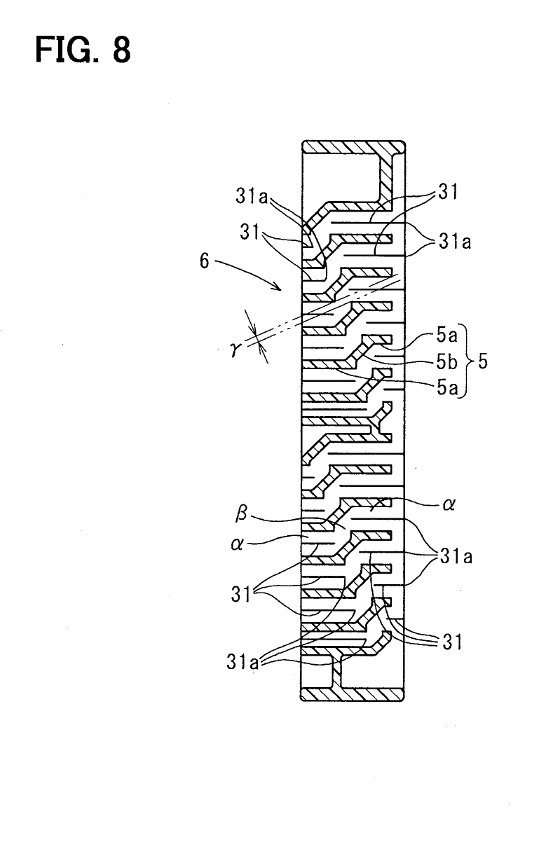

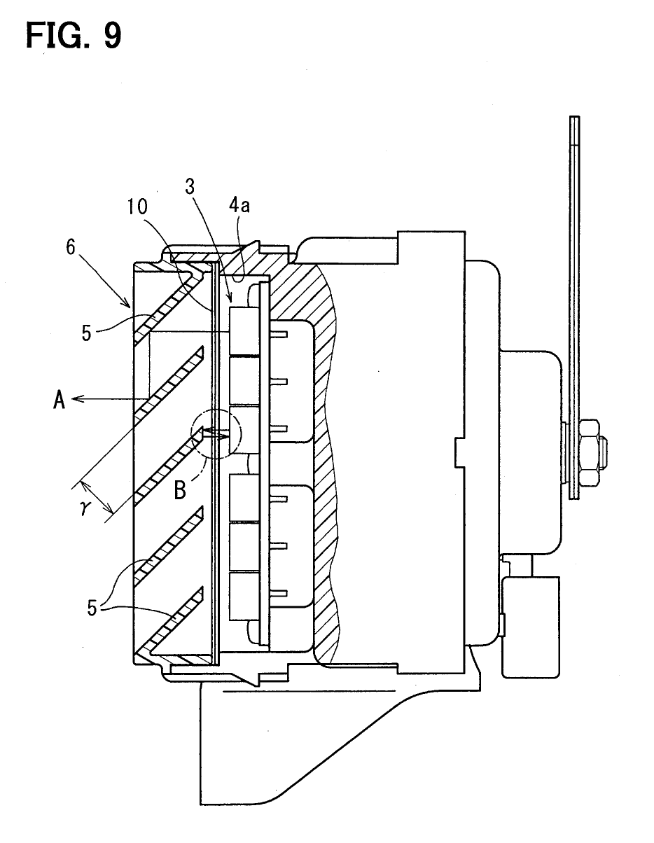

As follows, the fifth embodiment will be described with reference to FIG. 8. In the above-described fourth embodiment, the horizontal plate 31 is provided only in the inclined clearance β on the side of the ultrasonic emission device 3. To the contrary, in the present fifth embodiment, as shown in FIG. 8, the horizontal plates 31 are provided in both:

(i) the horizontal clearance a on the side opposite from (different from) the ultrasonic emission device 3 through the inclined clearance β, i.e., on the front side of the vehicle relative to the inclined clearance β; and

(ii) the horizontal clearance a on the side of the ultrasonic emission device 3 relative to the inclined clearance β, i.e., on the rear side of the vehicle relative to the inclined clearance β.

In the present configuration, the horizontal plate 31 located in the horizontal clearance a on the front side of the inclined clearance β restricts atomization of rainwater in the louver 6. Furthermore, the horizontal plate 31 located in the horizontal clearance a on the rear side of the inclined clearance β condensates rainwater atomized in the louver 6. That is, the horizontal plates 31 located on both side of the inclined clearance β further restrict atomized rainwater from passing though the louver 6. Thus, the waterproofness of the ultrasonic speaker 2 can be further enhanced.

In the above embodiments, only the parametric speaker 1 is caused to emit the annunciation sound. It is noted that, the parametric speaker 1 may be combined with a dynamic speaker. In this configuration, both the parametric speaker 1 and the dynamic speaker may be caused to emit an annunciation sound. Further in this case, the vehicular horn buzzer 8 may be employed as the dynamic speaker.

In the above embodiments, the ultrasonic speaker 2 is equipped to the vehicular horn buzzer 8. It is noted that, the ultrasonic speaker 2 may be equipped to the vehicle individually from the vehicular horn buzzer 8.

In the above embodiments, the present disclosure is applied to the ultrasonic speaker 2 for the vehicle proximity annunciator device equipped to an automobile. It is noted that, the present disclosure may be applied to an ultrasonic speaker 2 equipped to a vehicle, such as a vessel, other than the automobile.

The present disclosure may be applied to an ultrasonic speaker 2 placed in a stationary facility, such as a station home or a sidewalk, out of doors for implementing, for example, audio guidance.

In the ultrasonic speaker, the multiple louver boards therebetween define both the horizontal clearance along the horizontal direction and the inclined clearance being ascent inclination toward the ultrasonic emission device. The combination of the horizontal clearance and the inclined clearance reduces the passage width of rainwater. Therefore, it is possible to suppress increase in the number of the louver boards and to suppress passage of rainwater. The present configuration restrains the number of the louver boards. Therefore, it is possible to reduce the rate of ultrasonic waves reflected on the ends of the louver boards toward the ultrasonic emission device. That is, the louver employed in the ultrasonic speaker enables to maintain the radiant efficiency of the ultrasonic wave and to inhibit passage of rainwater therethrough.

In the ultrasonic speaker, on the premise that: the x-axis extends along the emission direction in which the ultrasonic emission device is configured to emit the ultrasonic wave; the y-axis extends in the horizontal direction; and the z-axis extends in the vertical direction, each of the louver boards may be arranged, such that its longitudinal direction is along the y-axis direction, and each of the louver boards may include both: the horizontal plate portion, which is located along the x-axis direction; and the inclined plate portion, which is inclined relative to the x-axis to define an ascent inclination in the arrangement direction toward the ultrasonic emission device. In this case, the horizontal plate portions may form the horizontal clearance therebetween; and the inclined plate portions may form the inclined clearance therebetween. The present configuration produces the above-described operation effects.

Referring to FIG. 2C, the inclined plate portions may be in an inclination arrangement such that the inclined clearance on the directly lower side is closer to the ultrasonic emission device than the inclined clearance on the directly upper side when being viewed in the y-axis direction. The inclination arrangement of the multiple inclined plate portions in this way further reduces the passage width of rainwater between the louver boards thereby to restrict rainwater from passing therethrough.

The lower edge corner may be formed in the lower edge of the inclined plate portion formed to enhance longevity of the molding die. In this case, the lower edge corner may have the ultrasonic opposed surface opposed to the ultrasonic emission device. In this case, the ultrasonic opposed surface may be a round surface (FIG. 6B), which has the cross section being in the arc shape inclined downward, or an angled surface (FIG. 6C), which is inclined downward. In the present configuration, the ultrasonic waves colliding with the round surface or the angled surface are partially or entirely reflected toward the louver board on the lower side and are reflected again outward from the louver board on the lower side. The present configuration equipped with the round surface or the angled surface reduces the rate that the ultrasonic waves returned toward the ultrasonic emission device. Thus, the radiation rate of the ultrasonic waves emitted outward can be enhanced.

The ultrasonic speaker may be used for the parametric speaker configured to emit the ultrasonic wave, which is generated by implementing the ultrasonic modulation on the annunciation sound signal, to the outside of the vehicle. That is, the disclosure may be applied to the ultrasonic speaker for the vehicle proximity annunciator device using the parametric speaker. With the present configuration, the louver employed in the ultrasonic speaker equipped to the vehicle enables to maintain the radiant efficiency of the ultrasonic wave and to inhibit passage of rainwater therethrough.

The louver may be equipped with the horizontal plate located in the horizontal clearance and extended along the horizontal direction. In the present configuration, the horizontal plate reduces or eliminates the passage width of rainwater. Therefore, even when rainwater is strongly blown from the lower side toward the louver 6, the rainwater can be restricted from passing through the louver without making contact with the inner components, such as the horizontal plate, of the louver. In addition, when rainwater blown upward collides with the horizontal plate, and the atomized rainwater can be condensed into a water drip. Therefore, even when rainwater is atomized, it is possible to restrict atomized rainwater from passing through the louver.

The horizontal plate may be in an acute angle at the tip end on the side of the ultrasonic emission device. With the present configuration, the tip end of the horizontal plate is less apt to reflect the ultrasonic wave, which is emitted from the ultrasonic emission device, toward the ultrasonic emission device. Therefore, reduction in the radiant efficiency of the ultrasonic wave due to reflection on the tip end of the horizontal plate can be avoidable.

The horizontal plate may be located on the side of the ultrasonic emission device side relative to the inclined clearance. With the present configuration, even when rainwater is blown from the lower side strongly to the louver, and consequently, the rainwater is partially atomized in the upstream of the horizontal plate, the atomized rainwater can be condensed into a water drip when colliding with the horizontal plate. Therefore, it is possible to restrict atomized rainwater from passing through the louver.

The horizontal plate may be formed on both sides of the inclined clearance. That is, the horizontal plate may be formed on both the side of the ultrasonic emission device and on the opposite side from the ultrasonic emission device. In the present configuration, rainwater blown upward can be redirected downward with the horizontal plate on both the upstream side of the inclined clearance and the downstream side of the inclined clearance. Therefore, atomization of rainwater can be restrained, and condensation of rainwater can be promoted. The above structures of the embodiments can be combined as appropriate.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An ultrasonic speaker comprising:
an ultrasonic emission device configured to generate an ultrasonic wave;
a housing accommodating the ultrasonic emission device, the housing having an ultrasonic emission port for emitting the ultrasonic wave from the ultrasonic emission device outward therethrough; and
a louver equipped to the ultrasonic emission port, the louver including a plurality of louver boards, which are distant from each other to form a clearance therebetween, wherein
each clearance between the plurality of louver boards includes both:
a horizontal clearance extending along a horizontal direction; and
an inclined clearance being an ascent inclination toward the ultrasonic emission device.

2. The ultrasonic speaker according to claim 1, wherein
an x-axis extends along an emission direction in which the ultrasonic emission device is configured to emit an ultrasonic wave,
a y-axis extends in the horizontal direction,
a z-axis extends in a vertical direction, wherein
each of the plurality of louver boards is arranged such that its longitudinal direction extends along the y-axis direction,
the plurality of louver boards respectively include both:
horizontal plate portions located along the x-axis direction; and
inclined plate portions inclined relative to the x-axis to respectively define ascent inclinations toward the ultrasonic emission device,
the horizontal clearance is formed between the horizontal plate portions, and
the inclined clearance is formed between the inclined plate portions.

3. The ultrasonic speaker according to claim 2, wherein the plurality of inclined plate portions are in an inclination arrangement such that the inclined clearance on a directly lower side relative to one of the inclined plate portions is closer to the ultrasonic emission device than the inclined clearance on a directly upper side relative to the one of the inclined plate portions when being viewed in the y-axis direction.

4. The ultrasonic speaker according to claim 2, wherein
the inclined plate portion has a lower edge defining a lower edge corner for extending longevity of a molding die for molding the louver,
the lower edge corner has an ultrasonic opposed surface opposed to the ultrasonic emission device, and
the ultrasonic opposed surface is one of:
a round surface having a cross section being in an arc shape and inclined downward; and
an angled surface inclined downward.

5. A parametric speaker configured to emit an ultrasonic wave, which is generated by implementing an ultrasonic modulation on an annunciation sound signal, to an outside of a vehicle, the parametric speaker comprising:
the ultrasonic speaker according to claim 1.

6. The ultrasonic speaker according to claim 1, further comprising:
a horizontal plate located in the horizontal clearance and extended along the horizontal direction.

7. The ultrasonic speaker according to claim 6, wherein
the horizontal plate has a tip end on a side of the ultrasonic emission device, and
the tip end is in an acute shape.

8. The ultrasonic speaker according to claim 6, wherein the horizontal plate is located in the horizontal clearance on a side of the ultrasonic emission device relative to the inclined clearance.

9. The ultrasonic speaker according to claim 8, wherein the horizontal plate is located in the horizontal clearance on an opposite side from the ultrasonic emission device across the inclined clearance.

10. A vehicle proximity annunciator device configured to notify existence of a vehicle, the vehicle proximity annunciator device comprising:
the ultrasonic speaker according to claim 1.

11. An ultrasonic speaker comprising:
an ultrasonic emission device configured to generate an ultrasonic wave;
a housing accommodating the ultrasonic emission device, the housing having an ultrasonic emission port for emitting the ultrasonic wave from the ultrasonic emission device outward therethrough; and
a louver equipped to the ultrasonic emission port, the louver including a plurality of louver boards, which are distant from each other, wherein
each pair of the plurality of louver boards adjacent to each other forms a clearance therebetween,
the clearance includes both:
a horizontal clearance extending along a horizontal direction; and
an inclined clearance being at an angle relative to the horizontal direction and being an ascent inclination toward the ultrasonic emission device.
